(19) United States
(12) Patent Application Publication
(10) Pub. No.: US 2006/0148371 A1
(43) Pub. Date: Jul. 6, 2006

(54) Method of creating folded toy airplanes with printed indicia

(76) Inventor: Blake Waller, Denmark, SC (US)

Correspondence Address: MCNAIR LAW FIRM, P.A., P.O. BOX 10827, GREENVILLE, SC, 29603-0827, US

(21) Appl. No.: 11/321,499

(22) Filed: Dec. 29, 2005

Related U.S. Application Data
(60) Provisional application No. 60/639,967, filed on Dec. 30, 2004.

(51) Int. Cl. A63H 27/16; B42D 15/00

(52) U.S. Cl. 446/34; 446/67; 283/56; 283/117

(57) ABSTRACT

The invention is directed to a foldable sheet for receiving indicia and forming a folded toy airplane with visible indicia. The foldable sheet includes a plurality of fold lines forming a fuselage area of an airplane; a plurality of score lines forming wing areas of an airplane and a tab and a tab receiving member; and alignment lines for indicating the portions of the airplane that will be visible once folded. The sheet forms an airplane with visible indicia when cut along the score lines and folded along the fold lines and the tab is inserted in the tab receiving member. The sheet may further comprise indicia for being added to the sheet for being viewed after the airplane is formed. The score lines of the sheet may be offset wherein the sheet may vary in thickness without affecting the shape of the airplane.

### CROSS REFERENCE TO RELATED APPLICATION

This application claims priority from a provisional application filed Dec. 30, 2004, under Ser. No. 60/639,967, having the same title.

### FIELD OF THE INVENTION

The present invention is directed to paper airplanes, and more specifically, to a method for making toy airplanes whereby indicia is printed on the airplanes in locations that make them visible.

### BACKGROUND OF THE INVENTION

Items containing printed indicia have traditionally been used to meet advertising, entertainment, instructional, educational, and informational needs. The general public requires a medium for achieving these needs that allows for cost effective mass production of pre-printed objects that prominently display logos, designs, educational information, advertising, instructional information, trademarked words and designs, and other printed indicia tailored to these needs. It is also desirable that such an item be interactive and in the form of a foldable toy airplane, which the user is tempted to retain.

U.S. Pat. No. 1,420,805 discloses a toy airplane. The plane is constructed from a single blank of Bristol board or paper that is scored or creased so that it may readily folded into shape. The object of the plane is to provide a device that can be manufactured at a small cost for advertising purposes.

U.S. Pat. No. 2,086,361 discloses an airplane kite and advertising means. The kite is equipped with a rod and a fan wheel that assists the kite in achieving lift with the fan acting as a propeller. Several of the kites can be used together to carry an advertising sign between them.

U.S. Pat. No. 2,154,487 discloses a method for making a complete toy airplane out of a single piece of sheet material without gluing or using any other parts for weighting or balancing. The single piece of sheet material is preferably bond paper and is scored and slit for quick folding into a complete and usable toy.

U.S. Pat. No. 2,529,979 discloses a sheet material toy aircraft. The aircraft is constructed out of a blank sheet material without the need for using glue or any other fastening elements. The sheet material is equipped with creases and crease lines that provide for quick folding and construction of the aircraft.

U.S. Pat. No. 4,377,052 discloses a folded paper airplane. The airplane is made out of a single sheet of material that is pre-identified with a series of fold lines and cut segments. The patent discloses the ability to provide informational and advertising material on the plane in two places on the fuselage of the plane.

U.S. Pat. No. 6,080,094 discloses a stepper advertising device and method. A printed advertising device is formed by folding a sheet to form a wrapper. Other patents showing toy airplanes include U.S. Pat. No. 865,419, issued Sep. 10, 1907 to Moorhead (toy aeroplane); U.S. Pat. No. 3,010,250, issued Nov. 28, 1961 to Huston, Jr. (toy airplane); U.S. Pat. No. 4,012,865, issued Mar. 22, 1977, to Fields (toy airplane of foldable sheet material); and U.S. Pat. No. 5,482,489, issued Jan. 9, 1996, to Stone (folding toy plane).

None of the above inventions and patents, taken either singly or in combination, is seen to describe the instant invention as claimed. Thus, a method of creating folded toy airplanes with printed indicia that solves the aforementioned problems is desired.

### SUMMARY OF THE INVENTION

The invention is directed to a method for creating folded toy airplanes with printed indicia, comprising the steps of providing a foldable sheet; adding a series of fold lines to the sheet, fold lines being arranged on the sheet in order to simulate the shape of an airplane having a cockpit, a pair of wings, a fuselage, arid a tailpiece; adding a plurality of scored cut lines, the cut lines being located on the sheet for shaping the tailpiece and the wings for the airplane; adding indicia to the sheet, the indicia being located between the fold lines and the cut; cutting the sheet along the cut lines forming the tailpiece and the wings; and folding the sheet along the fold lines to form the shape of the airplane with the indicia being visible. The method of claim 1 may also include the step of offsetting the scored cut lines whereby the sheet may vary in thickness without affecting the shape of the airplane. The plurality of scored cut lines may further form a tab and a tab receiving member. Folding the sheet may also include inserting the tab in the tab receiving member whereby the plane is secured in its formed position. The toy airplane may be formed from one or more sheets of foldable material. The indicia may comprise promotional indicia for promotional uses, educational indicia for educational purposes, instructional indicia for assisting in instruction, and/or entertainment indicia for entertainment purposes.

The invention may also be directed to a foldable sheet for receiving indicia and forming a folded toy airplane with visible indicia. The foldable sheet includes a plurality of fold lines forming a fuselage area of an airplane; a plurality of score lines forming wing areas of an airplane; the score lines further forming a tab and a tab receiving member; and alignment lines for indicating the portions of the airplane that will be visible once folded. The sheet forms an airplane with visible indicia when cut along the score lines and folded along the fold lines and the tab is inserted in the tab receiving member. The sheet may further comprise indicia for being added to the sheet for being viewed after the airplane is formed. The indicia may comprise advertising indicia for being viewed after the airplane is formed. The score lines of the sheet may be offset wherein the sheet may vary in thickness without affecting the shape of the airplane.

### BRIEF DESCRIPTION OF THE DRAWINGS

FIG. 1 is a perspective view illustrating a folded toy airplane with printed indicia according to the present invention,

FIG. 2 is a top plan view of one side illustrating a foldable sheet having printed or scored thereon lines defining folds, cuts, and indicia for forming a folded toy airplane according to the invention,

FIG. 3 is a top plan view illustrating the opposite side of the blank of foldable sheet material of FIG. 2, having printed or scored thereon lines marking folds, cuts, and indicia for forming a folded toy airplane according to this invention,

FIGS. 4 and 5 are top plan views illustrating the steps in forming the sheet of FIGS. 2, 3 into the folded toy plane of FIG. 1,

FIG. 6 is a top plan view illustrating an embodiment of the invention,

FIG. 7 is a side elevation illustrating the sheet of FIG. 6 partially folded according to the invention,

FIG. 8 is a side elevation illustrating a portion of FIG. 8, and

FIG. 9 is a side elevation illustrating a folded airplane according to the invention.

Similar reference characters denote corresponding features consistently throughout the attached drawings.

### DETAILED DESCRIPTION OF THE PREFERRED EMBODIMENTS

The present invention is a method of creating folded and formed toy airplanes with printed indicia. An exemplary paper airplane with printed indicia is designated generally as 10 in the drawings.

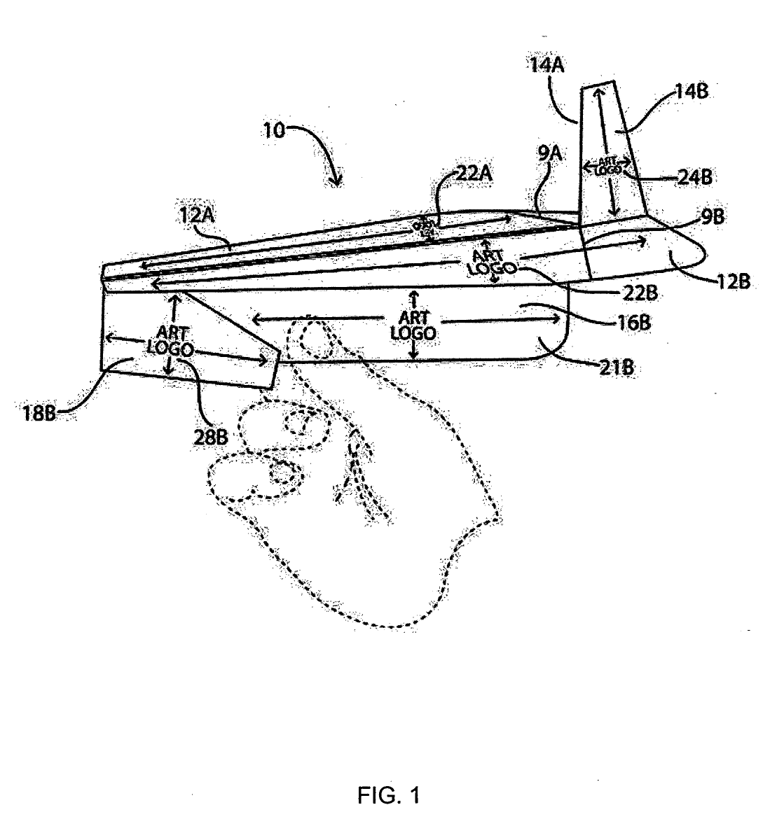

Referring to FIG. 1 of the drawings, the folded toy airplane 10 is constructed with wings 12, a cockpit 18, a tailpiece 14, and a fuselage 16. Printed indicia 22A and 22B are displayed on the wings 12A and 12B and may cover any exposed area of wings 12. Printed indicia 28B are also displayed on the cockpit 18B and may cover any exposed area of cockpit 18B. Printed indicia 24B are further displayed on tailpiece 14 and may cover any exposed area of tailpiece 14B. Still more printed indicia 26B are displayed on fuselage 16 and may cover any exposed area of fuselage 16B.

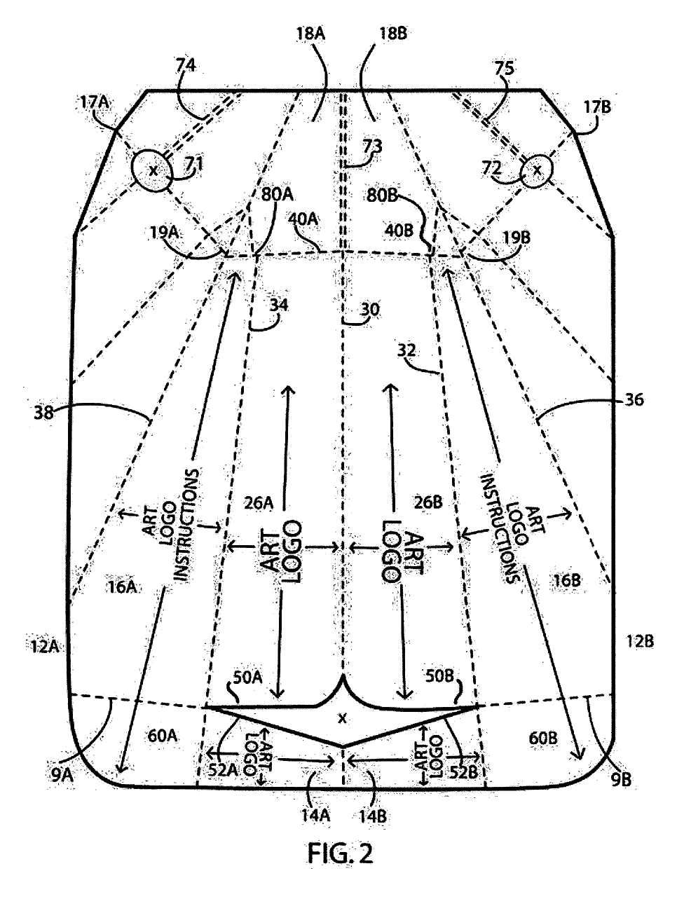

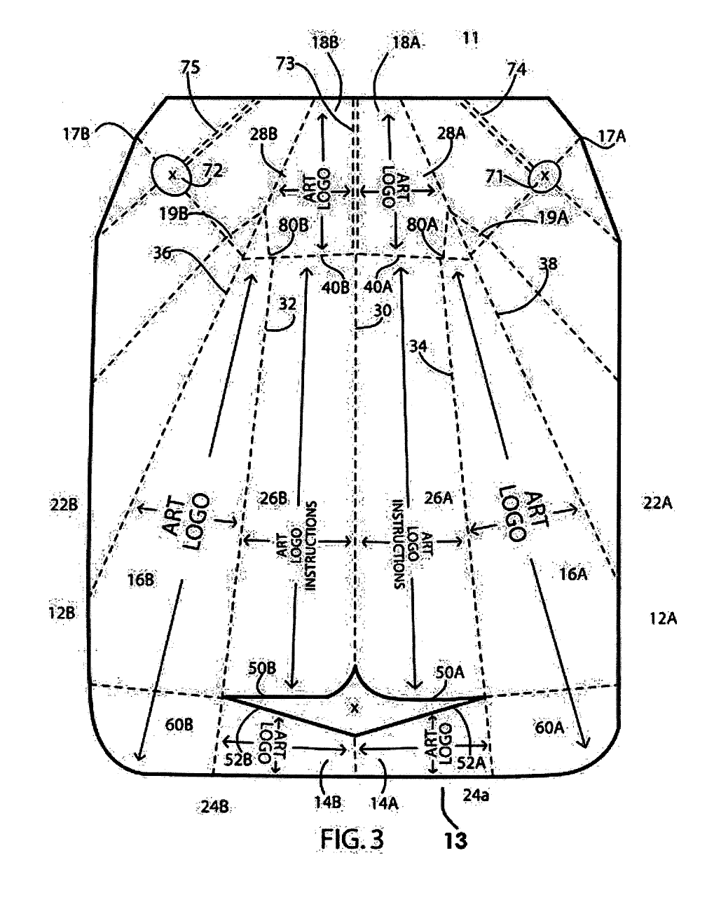

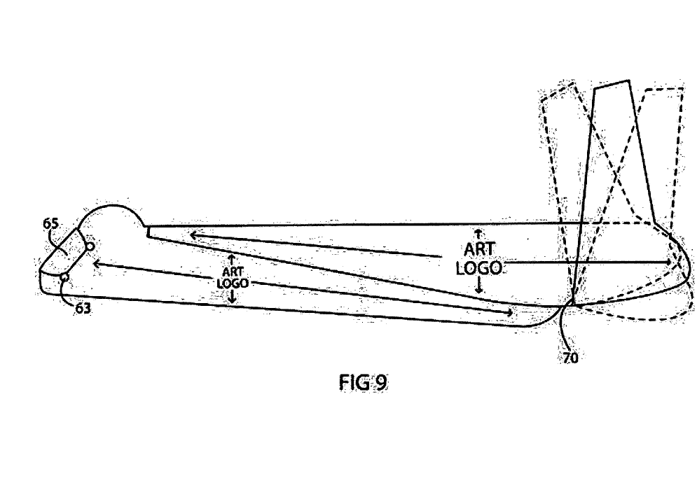

FIG. 2 and FIG. 3 illustrate both sides of a sheet used for constructing folded toy airplane 10. The sheet has forward edge 11 and rear edge 13 and each side contains creases, score lines, form lines or printed indicia that constitute instructional identification of various fold lines, 30, 32, 34, 36, 38, 40, 40A, cut lines 50, 50A, 52, 52A, 60, 60A, and cutout or die cut segments marked X. As can best be seen in FIG. 2, one side of the sheet is printed with indicia 26 that are displayed on fuselage 16. As seen in FIG. 3, the opposite side of the blank sheet is printed with indicia 22, 24, 28 that are displayed on wings 12, fuselage 16, and cockpit 18, respectively. Score lines 9A and 9B allow for tail adjustment for flight enhancement as illustrated in FIG. 9. Score lines 19A and 19B are offset at the intersections of 17A and 40A and 17B and 40B to allow for materials of varying thickness to be used in creating the airplane. Score lines 73, 74, 75, 80A and 80B are likewise offset. Cutouts 71 and 72 relieve folding stress at the intersection of 30 and 19A and 30 and 19B.

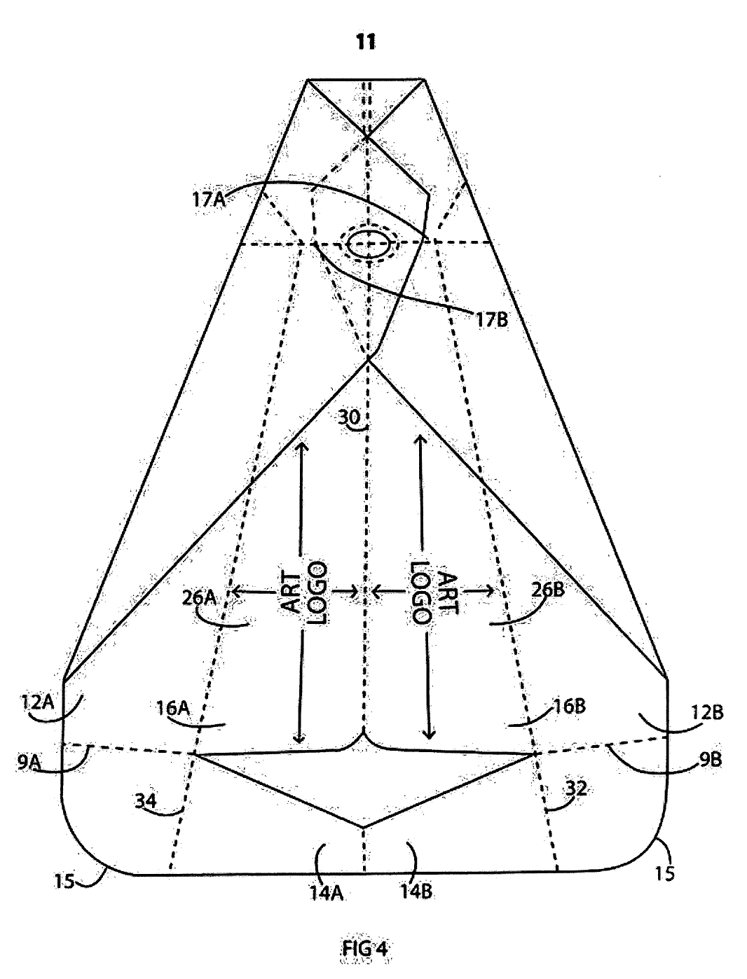

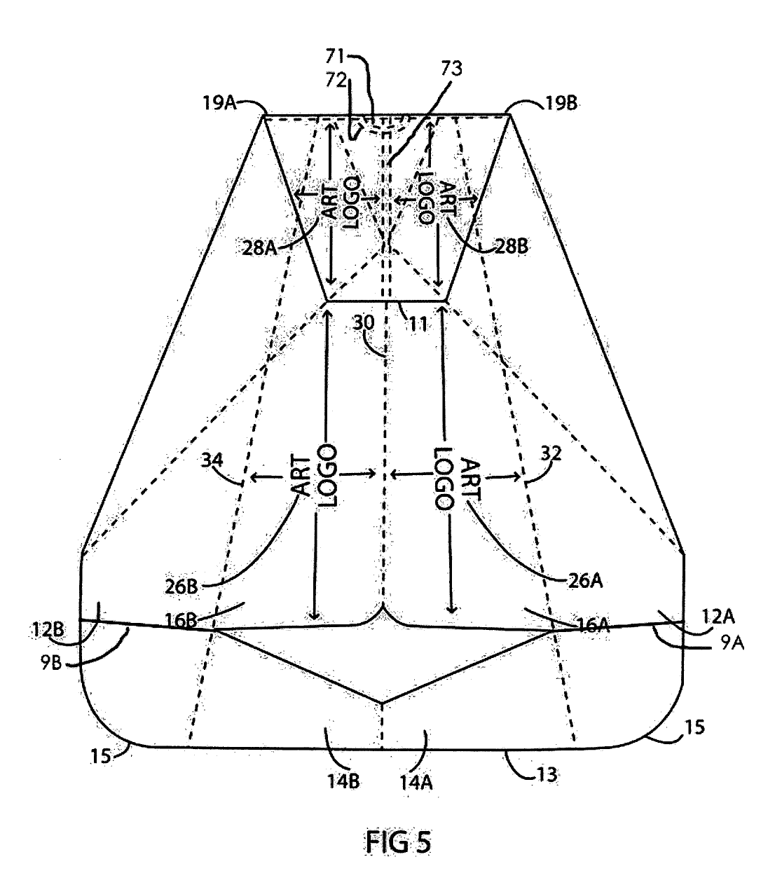

FIG. 4 and FIG. 5 show the steps that result in the structure of completed folded toy airplane 10 as seen in FIG. 1. Beginning with the side of the sheet as shown in FIG. 2 facing upward, the first step is to remove the cutout segments marked X by removing die cut sections or by cutting along scored or perforated lines 50, 50A, 52, 52A, 60, and 60A. The removal of the cut-out segments results in the curved portion of the wings 15 and the curved portion of the fuselage 21. Next, the sheet is folded along fold line 38 with corner 17 resting at point 19A, located at the intersection of fold line 36 and fold line 40A. The sheet is then folded along fold line 36 with corner 17A resting substantially at the intersection of fold line 38 and fold line 40. Forward edge 11 is then folded forward along fold lines 40, 40A and the resulting piece is then folded inward along fold lines 32, 34 to form the wings. The entire resulting piece can be folded along centerfold line 30 to complete the folded toy airplane 10 as shown in FIG. 1.

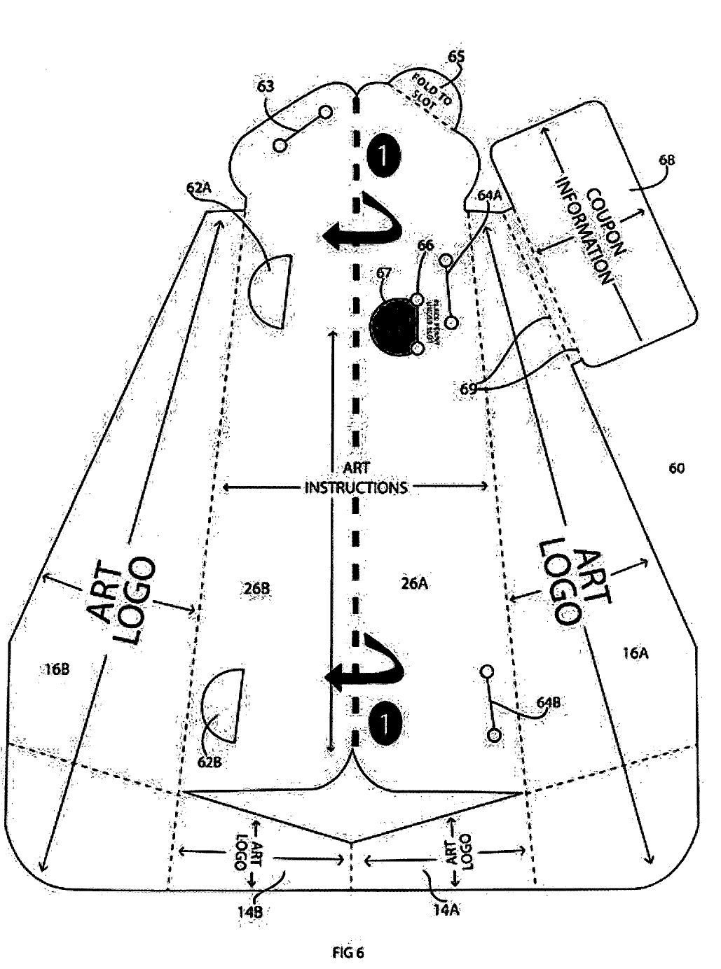

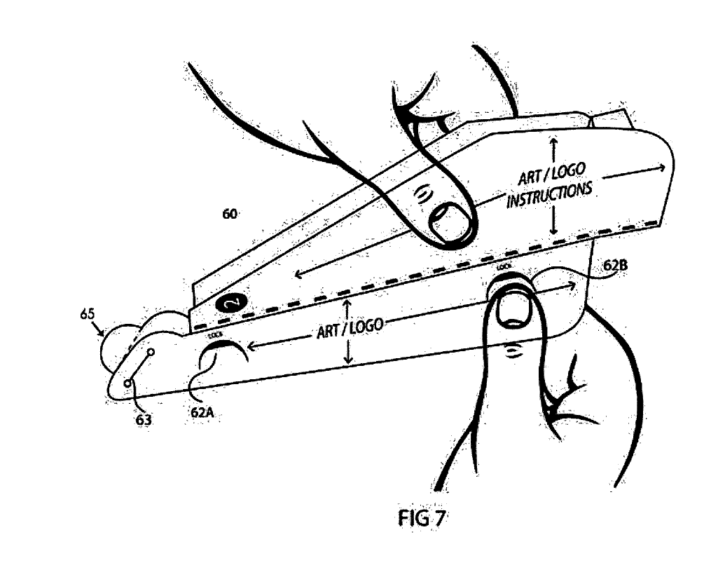

Referring now to FIGS. 6, 7 and 8, a further embodiment of the invention is disclosed. FIG. 6 is a top plan view illustrating the plane portion of a blank sheet already cut out. The plane portion 60 of the sheet includes tabs 62A and 62B. Further, plane 60 includes tab receiving members 64A and 64B. As can best be seen in FIG. 7, once plane 60 has been folded according to fold lines, the tabs 62A and 62B align with tab receiving members 64A and 64B. Slot 66 is provided for the insertion of a penny

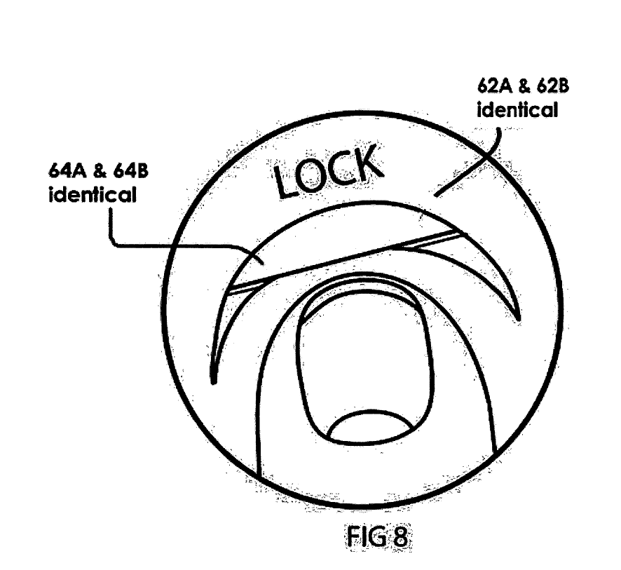

The penny provides weight in a strategic location for flight aerodynamics. FIG. 6 also illustrated coupon 68 included on the airplane. This coupon may be detached via micro-perf scores 69 which allow for smooth removal. Coupon 68 may be used in conjunction with the plane for advertising purposes. FIG. 8 illustrates in more detail the process of pushing tab 62B into tab receiving member 64B. Thus, the plane is completed and held together without the use of glue, staples, or tape. Tabs 62A and 62B and tab receiving members 64A and 64B maintain the plane in a folded position. FIG. 9 illustrates the completed folded plane with printable indicia and moveable tail according to the invention.

The preferred material of construction of the present invention is paper. However, it is within the contemplation of the present invention to utilize plastic or any other materials.

The embodiment shown in the described drawings refers to perforated lines, and form lines in creating the design of the toy airplane with printed indicia However, it is understood that the present invention should not be limited to this design, but encompasses the any combination of die cut sections, cut out sect fold lines, perforated lines, and form lines for creating folded and formed toy airplane designs.

The embodiment shown in the described drawings refers to the use of logo indicia visible on the toy airplane. However, it is understood that the present invention should not be limited to the use of logo indicia, but encompasses the use of any printed indicia including logos, designs, information, advertising, instructional information, or other specific indicia on folded and formed toy airplanes.

It is to be understood that the present invention is not limited to the embodiments described above, but encompasses any and all embodiments within the scope of the following claims.

What is claimed:

1. A method of creating folded toy airplanes with printed indicia, comprising the steps of;
providing a foldable sheet;
adding a series of fold lines to said sheet, fold lines being arranged on said sheet in order to simulate the shape of an airplane having a cockpit, a pair of wings, a fuselage, arid a tailpiece;
adding a plurality of scored cut lines, said cut lines being located on said sheet for shaping said tailpiece and said wings for said airplane;
adding indicia to said sheet, said indicia being located between said fold lines and said cut;
cutting said sheet along said cut lines forming said tailpiece and said wings; and
folding said sheet along said fold lines to form the shape of said airplane with said indicia being visible.

2. The method of claim 1 further comprising the step of offsetting said scored cut lines whereby said sheet may vary in thickness whereby the shape of the airplane is not affected by the thickness of the sheet.

3. The method of claim 1 wherein said plurality of scored cut lines further form a tab and a tab receiving member.

4. The method of claim 1 wherein said step of folding said sheet includes inserting said tab in said tab receiving member whereby said plane is secured in its formed position.

5. The method of claim 1, wherein said toy airplane can be formed from one or more sheets of foldable material.

6. The method of claim 1, wherein said indicia comprise promotional indicia for promotional uses.

7. The method of claim 1, wherein said indicia comprise educational indicia for educational purposes.

8. The method of claim 1, wherein said indicia comprise instructional indicia for assisting in instruction.

9. The method or claim 1, wherein said indicia comprise entertainment indicia for entertainment purposes.

10. A foldable sheet for receiving indicia and forming a folded toy airplane with visible indicia comprising:
a plurality of fold lines forming a fuselage area of an airplane;
a plurality of score lines forming wing areas of an airplane;
said score lines further forming a tab and a tab receiving member; and
alignment lines for indicating the portions of the airplane that will be visible once folded;
whereby said sheet forms an airplane with visible indicia when cut along said score lines and folded along said fold lines and said tab is inserted in said tab receiving member.

11. The sheet of claim 10 further comprising indicia for being added to said sheet for being viewed after said airplane is formed.

12. The sheet of claim 10 wherein said indicia comprise advertising indicia for being viewed after said airplane is formed.

13. The sheet of claim 10 wherein said score lines are offset wherein said sheet may vary in thickness whereby the shape of the airplane is not affected by the thickness of the sheet.

14. The sheet of claim 10 wherein said score lines further form a coupon area for receiving advertising indicia.

15. The sheet of claim 14 wherein said score lines that form said coupon area comprise micro-perforation score lines.
